(19) United States
(12) Patent Application Publication
(10) Pub. No.: US 2019/0073915 A1
(43) Pub. Date: Mar. 7, 2019

(54) INTERACTIVE AND INSTRUCTIONAL INTERFACE FOR LEARNING

(71) Applicant: International Business Machines Corporation, Armonk, NY (US)

(72) Inventors: Denise A. Bell, Austin, TX (US); Jana H. Jenkins, Raleigh, NC (US); Jeffrey A. Kusnitz, Campbell, CA (US); Adriana A. Morales, Austin, TX (US)

(21) Appl. No.: 15/696,298

(22) Filed: Sep. 6, 2017

(51) Int. Cl. G09B 5/06; G06F 3/01; G06F 3/02; G06F 3/16; G09B 17/00; G09B 19/04

(52) U.S. Cl. CPC G09B 5/06; G06F 3/011; G06F 3/016; G06F 3/0227; G01S 11/06; G09B 17/006; G09B 19/04; G06F 2203/014; G06F 3/16

(57) ABSTRACT

Embodiments include techniques for implementing an interactive and instructional interface for learning, the techniques include displaying an image on a display, and producing an auditory representation of the image. The techniques also include updating values associated with one or more inputs according to the image, and detecting a proximity and arrangement corresponding to the one or more inputs. The techniques include providing feedback based at least in part on the proximity and arrangement corresponding to the one or more inputs.

### BACKGROUND

The present invention generally relates to digital devices, and more specifically, to an interactive and instructional interface for learning.

In today's environment, there are several educational and instructional tools available for learning how to read, write, and speak a language. Various participants learn at different rates and can benefit from using different methods incorporating visuals, auditory signals, hands-on learning experiences, and/or a combination thereof. For example, children that are in the early stages of language development have different needs when compared to an older person who is trying to advance their current language skills. Traditional techniques ascribe a single general method for teaching participants instead of tailoring the learning experience to the preferred style of each targeted participant.

### SUMMARY

Embodiments of the present invention are directed to a computer-implemented method, where the method includes displaying an image on a display, and producing an auditory representation of the image. The method also includes updating values associated with one or more inputs according to the image and detecting a proximity and arrangement corresponding to the one or more inputs. The method includes providing feedback based at least in part on the proximity and arrangement corresponding to the one or more inputs.

Embodiments of the present invention are directed to a system. A non-limiting example of the system includes a storage medium, the storage medium being coupled to a processor, the processor configured to display an image on a display, and produce an auditory representation of the image. The processor is further configured to update values associated with one or more inputs according to the selected image, and detect a proximity and arrangement corresponding to the one or more inputs. The processor configured to provide feedback based at least in part on the proximity and arrangement corresponding to the one or more inputs.

Embodiments of the invention are directed to a computer program product including a computer readable storage medium having program instructions embodied therewith. The program instructions are executable by a processor to cause the processor to perform a method. A non-limiting example of the method includes displaying an image on a display, and producing an auditory representation of the image. The method also includes updating values associated with one or more inputs according to the image and detecting a proximity and arrangement corresponding to the one or more inputs. The method includes providing feedback based at least in part on the proximity and arrangement corresponding to the one or more inputs.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram illustrating one example of a processing system for practice of the teachings herein;

FIG. 2 depicts a system for an interactive and instructional interface for learning in accordance with one or more embodiments;

FIG. 3 depicts an image block in accordance with one or more embodiments;

FIG. 4 depicts an arrangement of letter blocks in accordance with one or more embodiments; and

FIG. 5 depicts a flow diagram for operating an interactive and instructional interface for learning in accordance with one or more embodiments.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

There are several techniques and tools available for participants to practice their language skills. For example, technologies exist that engage one or more of the user's senses such as tactile, visual, auditory, etc. to provide an enhanced learning experience.

Turning now to an overview of the aspects of the invention, one or more embodiments of the invention address the above-described shortcomings of the prior art by providing an interface to stimulate a participant's development. The described game-like experience can engage users in an entertaining manner to increase the desire to practice and learn.

The participant is provided an image block displaying a visual that illustrates a noun, verb, or adjective. The image block can be configured with a speaker for providing an auditory representation of the image. The participant will have the opportunity to organize a set of letter blocks to spell the word corresponding to the image displayed on the image block. Each of the letter blocks are further configured with an indicator to provide feedback to the participant on the proper spelling of the word based on the sequence of the letter blocks.

In the event, the participant has correctly spelled and organized the letter blocks, positive feedback can be provided to the participant and a new image can be populated on the image block where the letters displayed on the set of letter blocks can be simultaneously updated with the image. A tailored learning experience is described herein.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

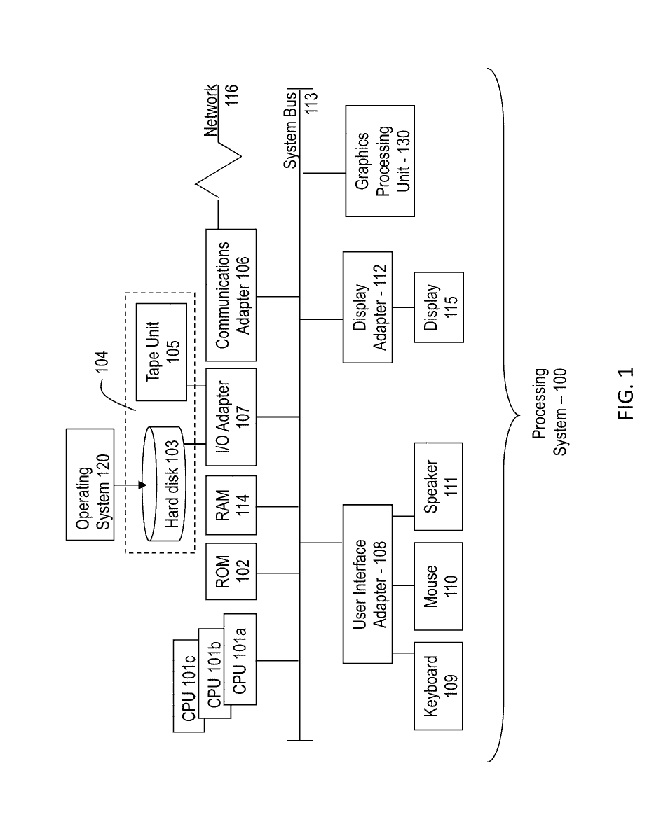

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

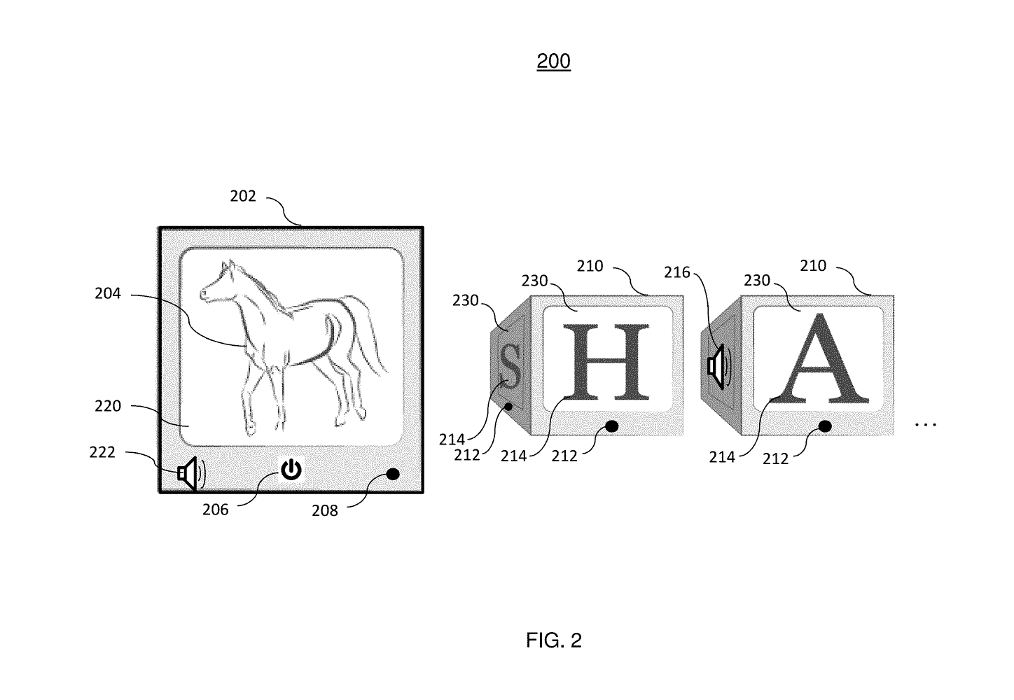

Turning now to a more detailed description of aspects of the present invention, FIG. 2 depicts a system 200 in accordance with one or more embodiments.

In one or more embodiments, the system 200 includes an image block 202 and one or more letter blocks 210, where the system 200 provides an interactive and instructional interface for learning. In one or more embodiments, the image block 202 and the letter blocks 210 can each comprise the system 100 of FIG. 1. The system 100 as shown is representative of the components that can be included in the system 200. In one or more embodiments, a user can interact with the system 200 audibly, visually, and tactilely. The system 200 can be used as an instructional tool to assist in learning skills related to reading, writing, and speaking. The system 200 includes an image block 202 which is configured to communicate over a network with one or more letter blocks 210. For example, the image block 202 and letter blocks 210 can communicate with each other using a near-field communications (NFC) standard. This set of communication protocols enable a plurality of devices to communicate with each other when the devices are brought within proximity of one another (e.g. 4 cm). In one or more embodiments, the blocks are configured to communicate over other wireless connections such as Wi-Fi.

The image block 202 as shown includes a power button 206 and an indicator 208. The indicator 208 can be used to indicate the image block 202 is powered on. In a different embodiment, the power button 206 can indicate that the image block 202 is powered on. The image block 202 is configured to display various images 204 on the display 220. The images can be stored within a memory of the image block 202. The displays 220 can be a liquid crystal display (LCD), light emitting diode (LED), or any other type of display or display device. In a non-limiting example, the image 204 displayed on the display 220 is a horse. In addition, a new set of images can be obtained and stored in the memory of the image block 202 over a network connection such as Wi-Fi. The image block 202 also includes a speaker 222 to provide instructions and/or feedback to a user.

The letter blocks 210 can be configured with a display 230 on each face of the letter blocks 210. In one or more embodiments, the letter blocks 210 include a digital display 230 on each face of the letter block 210 and has a speaker 216 included on one face of the letter block 210. The speaker 216 can be used to provide feedback to the user indicating which letter blocks 210 are in a correct position and which letter blocks 210 are not. In one or more embodiments, each of the letter blocks 210 can be equipped with sensors or detectors for determining an orientation of the letter blocks 210. The orientation of the letter blocks 210 refers to the letter blocks 210 being in the right-side-up orientation. In addition, the image block 202 and the letter blocks 210 can be equipped with sensors to detect the proximity of the other letter blocks 210. In a non-limiting example, the image block 202 can include proximity sensors to detect the distance of respective letter blocks 210. In a different example, the letter blocks 210 can include proximity sensors to determine its position relative to the other letter blocks 210 and transmit the position information to the image block 202. The imaged block 202 and letter blocks 210 can also be equipped with a communication interface for communicating between the image block 202 and letter blocks 210.

In one or more embodiments, the letter blocks 210 include an indicator 212 on each face of the letter blocks 210. In an example, the indicator 212 can be a red light or a green light, where the red light indicates an incorrect sequence of the letter blocks 210 corresponding to the image block 202. The green light indicates that letter blocks 210 are positioned in a correct sequence to spell the word for the image displayed on the image block 202. A red light indicates that a letter block 210 is not positioned in the correct sequence relative to the other letter blocks 210. In other embodiments, the color of the characters can be used to indicate the appropriate sequence or the outside border can light up indicating the correct sequence. In one or more embodiments, an audible indication can be used to provide feedback to the user of the correct sequence of the letter blocks 210 using the speaker 216. The audible feedback can be used in combination with other visible indicators.

In one or more embodiments, the indicators 212 of the letter blocks 210 can be updated in real-time to provide feedback to the user of the correct sequence of letter blocks 210 relative to the other letter blocks 210. In this example, the letter blocks 210 can provide an indication as the letter blocks 210 are positioned in sequence.

In one or more embodiments, the correct sequence of letters corresponding to a displayed image of the image block 202 that is compared to the sequence of letter blocks 210 can be stored in the memory of the image block 202. In a different embodiment, the image block 202 can send the correct sequence information to each letter block 202 where the letter blocks 210 can determine their current sequence based on the proximity relative to the other letter blocks 210 in the set.

In one or more embodiments, the image block 202 is pre-configured with a set of images. The pre-configured set of images can be stored in a memory of the image block 202. In other embodiments, the set of images can be updated over a connection to a network, wherein the corresponding set of available characters will be updated for the respective images.

In one or more embodiments, letter blocks 210 include one or more characters on each face of the letter blocks 210. As a non-limiting example, the characters can include letters of the English alphabet. Letters and characters of other languages can also be used. In addition, the characters displayed on each face of each letter block 210 can be dynamically updated. In one or more embodiments, the update can occur when the image block 202 is updated to display a new image on the display 220 of the image block 202. This allows the displays 230 of each letter block 210 to display various characters associated with a respective image displayed on the image block 202.

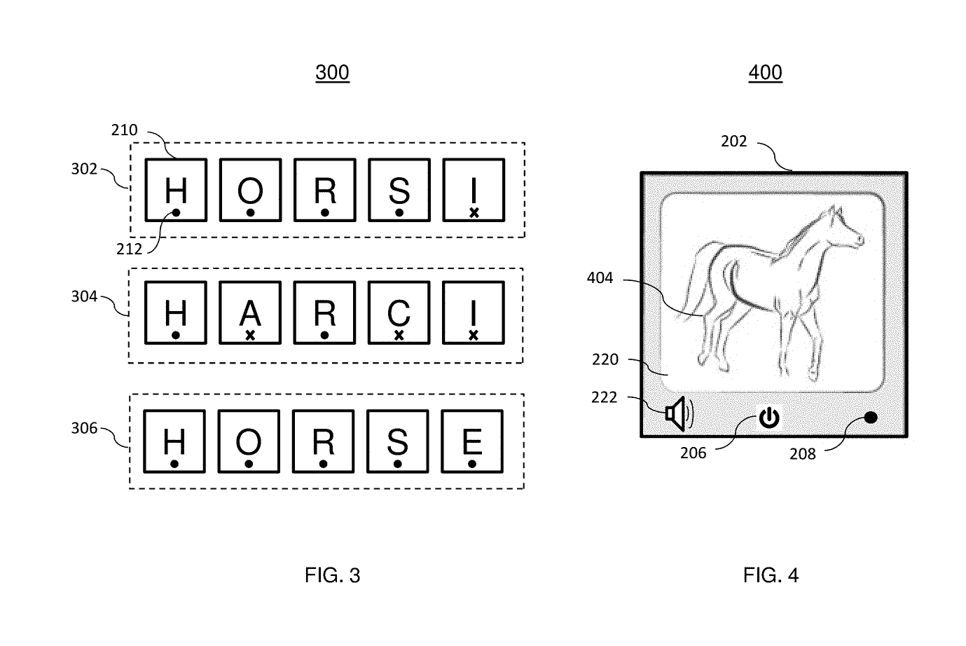

Now referring to FIG. 3, an arrangement 300 of letter blocks in accordance with one or more embodiments is shown.

In this non-limiting example, the correct sequence requires that the letter blocks 210 be arranged to spell the word “HORSE”, which corresponds to the image 204 of the horse displayed on display 220 of the image block 202. The first arrangement 302 illustrates an arrangement of letter blocks 210 that does not match the image of the image block 210. The image block 202 can receive input signals from each of the letter blocks 210 to determine the letters on the face of each letter block 210 and the sequence of each letter blocks 210. The received input signals can be used to determine the correct sequence. For example, the first letter block “H” can transmit an input signal to the image block 202 indicating that the letter block “H” is in the first position.

In one or more embodiments, the image block 202 can determine the proximity of each letter block 210 using a sensor to detect the distance and/or signal strength of each received input signal from the letter blocks 210. In a different embodiment, the letter blocks 210 can determine their position based on the signals received from other letter blocks 210 using a sensor to detect signals from the other blocks 210. The position information can be transmitted to the image block 202. The image block 202 can compare the first letter with the sequence of letters stored in its memory. The image block 202 can communicate with the letter block “H” indicating it is in the correct position in the sequence. The indicator 212 can provide feedback to the participant indicating whether each individual letter block 210 is in the correct sequence. The feedback provided in the indicator 212 can be based on the communication received from the image block 202. In this example, the feedback for the letter block “H” indicates that it is in the correct position. In one or more embodiments, different color lights can indicate a correct position and an incorrect position. In a different embodiment, symbols can be used to provide feedback to the participant.

The second letter block “0” transmits an input signal to the image block 202 where the image block 202 determines it is in the correct position in the sequence. The image block 202 communicates with the second letter block “0” to indicate it is in the correct position and the second letter block “0” provides the appropriate feedback to the participant using the indicator 212. The third letter block “R” and fourth letter block “S” follows a similar process as described above. The fifth letter block “I” transmits an input signal to the image block 202 where the image block 202 compares the input signal including the letter and the sequence information to the stored sequence corresponding to the image. The image block 202 determines the fifth letter block “I” is in the wrong position and communicates that information to the fifth letter block “I” where the appropriate feedback is provided to the participant using indicator 212. In this example, the arrangement 302 provides the first four letter blocks are in the correct position and the last letter block 210 having an “I” is either the wrong letter or in the wrong position using an “X” for the indication. In one or more embodiments, the feedback can include haptic feedback such as a pattern of vibrations or audio feedback can be provided to indicate whether a correct arrangement of letter blocks 210 has been determined by the image block 202. The haptic feedback can be provided by the image block 202 and/or letter blocks 210. The feedback can also be provided by the speaker 216 associated with each letter block 210. For example, an audible tone can be played to indicate an incorrect arrangement, while a different audible tone can be played to indicate a correct arrangement.

The arrangement 304 includes a plurality of letter blocks 210 having indicators 212. In this non-limiting example, the letter blocks 210 having the letters 214 “H” and “R” are shown to be in the correct position, while the remaining letter 214 “A”, “C”, and “I” are either in the wrong position or are incorrect letters. The image block 202 can receive input signals from each of the letter blocks 210 to determine the letters on the face of each letter block 210 and the sequence of each letter block 210.

The arrangement 306 includes a plurality of letter blocks 210. This example illustrates the correct arrangement 306 of letter blocks 210 that corresponds to the image 204 displayed on the image block 202 of FIG. 2. Arrangement 306 depicts a first letter block “H”, second letter block “0”, third letter block “R”, fourth letter block “S”, and fifth letter block “E”. The indicators 212 of each of the letter blocks 210 can provide positive feedback to the participant using the indicator 212 and/or speaker 216.

In one or more embodiments, responsive to detecting an incorrect attempt, a different variation of the same image can be displayed. For example, if the initial image is a horse, a different variation can include a different image of a horse or a horse that is shown in a different position.

In one or more embodiments, responsive to the image block 202 detecting a threshold number (e.g. three attempts) of incorrect attempts, a new image can be loaded on the display 220 of the image block 202, and the letter blocks 210 can be updated with a new set of letters corresponding to the updated image (e.g., letter used to spell a word describing what is shown in the updated image).

Now referring to FIG. 4, a block diagram 400 of an image block 202 in accordance with one or more embodiments is shown. The image block 202 is similar to the image block 202 shown in FIG. 2. The image block 202 includes the power button 206 and the indicator 208. The image 404 of image block 202 illustrates a different variation of the image 204 of the horse shown in FIG. 2. A different variation of the same image can be triggered in the image block 202 when an incorrect sequence of the letter blocks 210 is detected by the image block 202. For example, if the image block 202 detects, using proximity sensors, an incorrect sequence or arrangement of letter blocks 210 as shown in FIG. 3, arrangement 302 or 304, a different variation of the horse can be displayed. As subsequent incorrect sequences of letter blocks 210 are detected, another variation of the same image can be provided to the participant. In one or more embodiments, a new image can be selected that is different than the previous image. For example, after a number of incorrect attempts for spelling out horse, a dog may be displayed on the image block 202.

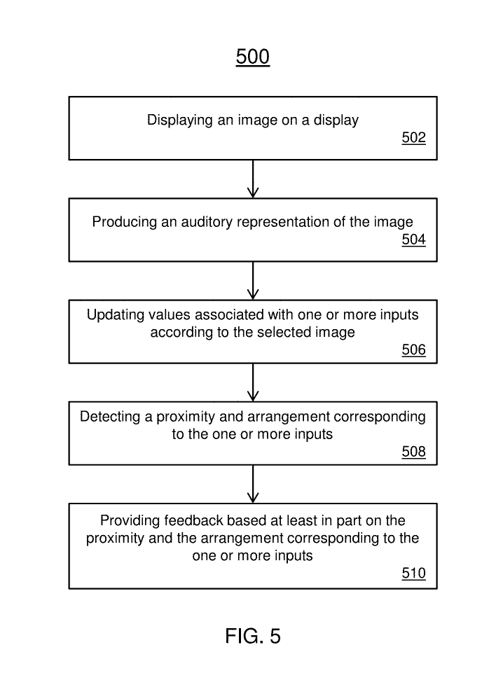

Now referring to FIG. 5, a technique 500 in accordance with one or more embodiments is provided. Block 502 provides displaying an image on a display. An image is selected and displayed on display 220 of image block 202. In one or more embodiments, the system 200 can randomly select an image to display on the display 220. In a different embodiment, an image selection can be triggered by shaking the image block 202. For example, the shaking can be detected by vibration/orientation sensors disposed within image block 202. In addition, gyroscopes and accelerometers can be used to detect the motions of the image block 202. Upon the detection by the sensors, an image or new image can be displayed on the display 220 of the image block 202.

Block 504 provides producing an auditory representation of the image. Responsive to the system selecting an image, the image block 202 can provide an auditory indication of the image. For example, with reference to FIG. 2, the speaker 222 of image block 202 can be used to produce a sound indicating that a “horse” is displayed in the image 204. In another example, the image block 202 can provide a sound related to the horse using speaker 222. In one or more embodiments, the image block 202 is configured with a button to trigger the auditory representation of the displayed image.

Block 506 provides updating values associated with one or more inputs according to the selected image. The one or more inputs include the received signals from the letter blocks 210. The inputs can indicate at least the letter on the letter block 210. The one or more inputs can also include position information within the sequence of other letter blocks 210 that has been determined by proximity sensors of the letter blocks 210 and/or proximity sensors of the image block 202. In one or more embodiments, the set of characters provided on each face of the letter blocks 210 can be populated and displayed after the image or new image is selected. This configuration allows for the re-use of the blocks as some words require different sets of letters and/or the repetitive use of characters. This can limit the number of additional letter blocks 210 that are needed. In one or more embodiments, additional letter blocks 210 can be paired with the image block 202 and letter blocks 210 as needed. In an example, the pairing can occur by pressing and holding the power button 206 for a duration of time to trigger a pairing mode with the additional letter blocks 210. During the pairing mode the additional letter blocks 210 can be positioned within close proximity to the image block 202 to become paired with it (i.e., positioned within 4 cm of the image block 202).

Block 508 provides detecting a proximity and arrangement corresponding to the one or more inputs. The image block 202 is configured to determine the proximity of the letter blocks 210 to the image block 202 using sensors/detectors to detect the signal strength of a signal from each letter block 210 and estimate the distance of the respective letter blocks 210. In one or more embodiments, the detection comprises determining whether the image corresponds to a sequence of the values based on detecting the proximity and arrangement corresponding to the one or more inputs. For example, the detection determines if the letter blocks 210 are placed in the correct sequence to form the word associated with the image shown on the image block 202, where the proximity of the letter blocks 210 to the image block 210 can be correlated to represent a sequence of the letter blocks 210. In one or more embodiments, the detection is triggered when the letter blocks 210 are brought within proximity of one another. In another embodiment, the detection is triggered at configurable periodic intervals. After the image block 202 determines whether the sequence of letter blocks 210 correctly spells the words corresponding to the image shown on the display 220 of the image block 202. In the event the sequence of letter blocks 210 is incorrect, the indicators 212 located on each individual letter block 210 can provide feedback of the correct position by visual, audio, and/or haptic feedback. In one or more embodiments, each of the letter blocks 210 can provide an audio signal representative of the letter when placed in a position relative to the other letter blocks 210.

In one or more embodiments, the values correspond to characters/letters on each face of one or more letter blocks 210. The letters that are on each face of the letter blocks 210 can be updated when the image block 202. In this scenario, the letters (values) are updated on each face prior to the detection. The inputs that are received at the image block 202 from the letter blocks 210 can be sent to the image block 202 as the user places the letter blocks 210 within proximity of one another.

In one or more embodiments, the one or more inputs are received from one or more letter blocks 210 indicating orientation information of each letter block 210. In one or more embodiments, the letter blocks 210 can be equipped with sensors, gyroscopes, and/or accelerometers to determine the orientation of the letter block 210. The letter block 210 determines the orientation to ensure the letter on the face the letter block 210 is in a right-side-up position. The letter block 210 can transmit this information to the image block 202 as an input. The one or more inputs can also include information indicating the letter shown on the face of the letter block 210. The one or more inputs can include information indicating a sequence of the letter block 210 in relation to other letter blocks 210. In a non-limiting example, the sequence of a letter block 210 in relation to other letter blocks 210 can be determined using proximity sensors disposed within the letter block 210. The one or more inputs can include information indicating a distance to an image block 202 based on a signal strength between the image block 202 and each letter block 210. In a non-limiting example, the image block 202 can determine the signal strength between the image block 202 and each letter block 210 based on a sensor disposed within the image block 202. An image block 202 can determine the signal strength to a first letter block and second letter block and so on. In a scenario, the image block 202 can correlate the signal strength to a distance such as a distance to the first letter block can be 4 cm, a second letter block 8 cm, and a third letter block 12 cm. The image block 202 can estimate a distance based on the signal strength of the input received from each letter block 210. After estimating the distances, the image block 202 can determine a sequence of the letter blocks 210.

In a different embodiment, each letter block 210 can indicate its sequence among a set of letter blocks 210 using proximity sensors that are able to detect signals from other letter blocks 210. Each letter block 210 can determine how many letter blocks 210 are positioned to its left and its right and send the sequence information as an input to the image block 202. The image block 202 uses the input to determine whether each of the letter blocks 202 are in the correct position by comparing the sequence of each of the letter blocks 202 to a stored sequence corresponding to the image displayed on the display 220 of the image block 202.

Block 510 includes providing feedback based at least in part on the proximity and the arrangement corresponding to one or more inputs. The feedback can include visual, audio, haptic feedback, and/or any combination thereof. The visual feedback can include using colors, symbols, or flashing patterns on each of the letter blocks 210. The audio feedback can include chimes, bells, voice, and/or other audio. The haptic feedback can include vibrations where various patterns of vibrations can be used to indicate a correct sequence of the letter blocks 210.

The techniques described herein improves over traditional methods for developing reading, writing, spelling skills, etc. using a limited number of blocks in a game-like scenario. The image and letter blocks can be dynamically updated with new images and words to continue the user's development. The adaptability of the blocks increases the usability and transcends the limitation of blocks having static letter blocks and/or image blocks. The system can also be configured to be universal by being configured in different languages and characters.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method, comprising:
displaying an image on a display;
producing an auditory representation of the image;
updating values associated with one or more inputs according to the image;
detecting a proximity and arrangement corresponding to the one or more inputs; and
providing feedback based at least in part on detecting the proximity and arrangement corresponding to the one or more inputs.

2. The method of claim 1, wherein the values correspond to characters displayed on a face of one or more letter blocks, wherein the one or more letter blocks are in communication with an image block comprising the display.

3. The method of claim 2, wherein the one or more inputs are received from the one or more letter blocks and indicate at least one of an orientation of each letter block, a letter on the face of the letter block, a sequence of the one or more letter blocks in relation to other letter blocks, or a distance to the image block based on a signal strength between the image block and the one or more letter blocks.

4. The method of claim 1, wherein the detection comprises determining whether the image corresponds to a sequence of the values based on the proximity and arrangement corresponding to the one or more inputs.

5. The method of claim 1, further comprising:
responsive to receiving a user input, displaying a new image on the display and replacing the values corresponding to the one or more inputs.

6. The method of claim 4, further comprising:
responsive to detecting that the image does not correspond to the sequence of values, displaying a different variation of the image on the display.

7. The method of claim 1, wherein the image is randomly selected from a set of pre-loaded images, and the feedback includes one of at least a visual, audio, or haptic response.

8. The method of claim 1, wherein the detecting is based on a near-field communication standard.

9. A system, comprising:
a storage medium, the storage medium being coupled to a processor;
the processor configured to:
display an image on a display;
produce an auditory representation of the image;
update values associated with one or more inputs according to the selected image;
detect a proximity and arrangement corresponding to the one or more inputs; and
provide feedback based at least in part on detecting the proximity and arrangement corresponding to the one or more inputs.

10. The system of claim 9, further comprising:
an image block comprising the display; and
one or more letter blocks in communication with the image block, wherein the values correspond to characters displayed on a face of the one or more letter blocks.

11. The system of claim 10, wherein the one or more inputs are received from the one or more letter blocks and indicate at least one of an orientation of each letter block, a letter on the face of the letter block, a sequence of the letter block in relation to other letter blocks, or a distance to the image block based on a signal strength between the image block and each letter block.

12. The system of claim 9, wherein the detection comprises determining the image corresponds to a sequence of the values based on the proximity and arrangement corresponding to the one or more inputs.

13. The system of claim 9, wherein the processor is further configured to: responsive to receiving an input from a participant, display a new image on the display and replace the values corresponding to the one or more inputs.

14. The system of claim 12, wherein the processor is further configured to: responsive to detecting that the image does not correspond to the sequence of the value, display a different variation of the image on the display.

15. The system of claim 9, wherein the image is randomly selected from a set of pre-loaded images, and the feedback includes one of at least a visual, audio, or haptic response.

16. The system of claim 9, wherein the detecting is based on a near-field communication standard.

17. A computer program product, comprising:
a computer readable storage medium having stored thereon program instructions executable by a processor to cause the processor to:
displaying an image on a display;
produce an auditory representation of the image;
update values associated with one or more inputs according to the selected image;
detect a proximity and arrangement corresponding to the one or more inputs; and
provide feedback based at least in part on detecting the proximity and arrangement corresponding to the one or more inputs.

18. The computer program product of claim 17, wherein the values correspond to characters displayed on a face of one or more letter blocks in communication with an image block comprising the display, wherein the one or more inputs are received from the one or more letter blocks and indicate at least one of an orientation of each letter block, a letter on a face of the letter block, a sequence of the letter block in relation to other letter blocks, or a distance to the image block based on a signal strength between the image block and each letter block.

19. The computer program product of claim 17, wherein the detection comprises determining whether the image corresponds to a sequence of the values based on the proximity and arrangement corresponding to the one or more inputs.

20. The computer program product of claim 17, wherein the program instructions further cause the processor to: responsive to receiving a user input, display a new image on the display replace the values corresponding to the one or more inputs.
